(19) United States
(12) Patent Application Publication
(10) Pub. No.: US 2011/0189444 A1
(43) Pub. Date: Aug. 4, 2011

(54) Material Element

(75) Inventor: Tiffany A. Beers, Portland, OR (US)

(73) Assignee: NIKE, INC., Beaverton, OR (US)

(21) Appl. No.: 12/847,804

(22) Filed: Jul. 30, 2010

Related U.S. Application Data
(63) Continuation-in-part of application No. 12/720,070, filed on Mar. 9, 2010.
(60) Provisional application No. 61/158,653, filed on Mar. 9, 2009.

(51) Int. Cl. B32B 7/00; B32B 7/02; B32B 3/26; B32B 3/00; B32B 9/04; A43D 11/00

(52) U.S. Cl. 428/192; 428/213; 428/304.4; 428/57; 428/411.1; 12/142 R

(57) ABSTRACT

A material element has a pair of cover layers, a plurality of first strip components, and a plurality of second strip components. The first strip components are located between cover layers, and the first strip components are secured to cover layers. The second strip components are located between cover layers. positioned between the first strip components, and are unsecured to the cover layers. In some configurations, the thicknesses of the strip components may be different and edges of the strip components may have a non-linear configuration.

### CROSS-REFERENCE TO RELATED APPLICATIONS

This U.S. patent application is a continuation-in-part and claims priority to U.S. patent application Ser. No. 12/720,070, which was filed in the U.S. Patent and Trademark Office on 9 Mar. 2010 and entitled Cushioning Elements For Apparel And Other Products, such U.S. patent application being entirely incorporated herein by reference. U.S. patent application Ser. No. 12/720,070 claims priority to provisional U.S. Patent Application Ser. No. 61/158,653, which was filed in the U.S. Patent and Trademark Office on 9 Mar. 2009 and entitled Cushioning Elements For Apparel And Other Products, such U.S. patent application being entirely incorporated herein by reference.

### BACKGROUND

Protective elements or materials that impart padding, cushioning, or otherwise attenuate impact forces are commonly incorporated into a variety of products. Athletic apparel, for example, often incorporates protective elements that shield the wearer from contact with other athletes, equipment, or the ground. As an example, a variety of underlayer garments incorporate protective elements that provide impact protection to various parts of a wearer, as well as pads used in American football and hockey. Helmets utilized during American football, hockey, bicycling, skiing, snowboarding, and skateboarding incorporate protective elements that impart cushioning to the head during falls or crashes. Similarly, gloves utilized in soccer (e.g., by goalies) and hockey incorporate protective elements that provide protection to the hands of a wearer. In addition to apparel, a variety of other products incorporate elements that impart padding, cushioning, or otherwise attenuate impact forces, including mats, chair cushions, and backpacks.

### SUMMARY

A material element is disclosed below as having a pair of cover layers, a plurality of first strip components, and a plurality of second strip components. The first strip components are located between cover layers, and the first strip components are secured to cover layers. The second strip components are located between cover layers. positioned between the first strip components, and are unsecured to the cover layers. In some configurations, the thicknesses of the strip components may be different and edges of the strip components may have a non-linear configuration.

A method of manufacturing an article of apparel having a configuration of footwear is also disclosed below. The method includes locating a plurality polymer strip components between a pair of cover layers, each of the strip components having a planar configuration. The strip components and cover layers are placed around a footwear last. Pressure and heat are applied to the strip components and the cover layers to (a) compress the strip components and the cover layers against an exterior surface of the footwear last and (b) mold the strip components and the cover layers to have a non-planar configuration that corresponds with a shape of the exterior surface of the footwear last. Additionally, at least one of the strip components and cover layers are secured to a sole structure of the footwear.

The advantages and features of novelty characterizing aspects of the invention are pointed out with particularity in the appended claims. To gain an improved understanding of the advantages and features of novelty, however, reference may be made to the following descriptive matter and accompanying figures that describe and illustrate various configurations and concepts related to the invention.

### FIGURE DESCRIPTIONS

The foregoing Summary and the following Detailed Description will be better understood when read in conjunction with the accompanying figures.

FIG. 1 is a perspective view of a material element.

FIG. 2 is an exploded perspective view of the material element.

FIG. 3 is a plan view of the material element.

FIGS. 4A-4C are cross-sectional views of the material element, as respectively defined by section lines 4A-4C in FIG. 3.

FIGS. 5A-5E are plan views corresponding with FIG. 3 and depicting further configurations of the material element.

FIGS. 6A-6F are cross-sectional views corresponding with FIG. 4A and depicting further configurations of the material element.

FIG. 7A-7C are perspective views depicting a method of manufacturing the material element.

FIGS. 8A-8C are cross-sectional views of the method of manufacturing the material element, as respectively defined by section lines 8A-8C in FIGS. 7A-7C.

FIGS. 9A-9C are perspective views depicting a method of molding the material element.

FIGS. 10A-10C are schematic cross-sectional views of the method of molding the material element, as respectively defined by section lines 10A-10C in FIGS. 9A-9C.

FIGS. 11A-11F are perspective views of various articles of apparel incorporating the material element.

FIG. 12 is a side elevational view of an article of apparel having a configuration of footwear.

FIG. 13 is a cross-sectional view of the footwear, as defined by section line 16-16 in FIG. 15.

FIGS. 14A-14C are side elevational views corresponding with FIG. 12 and depicting further configurations of the footwear.

FIG. 15A-15E are perspective views of a method of manufacturing the footwear.

FIGS. 16A-16E are side elevational views corresponding with FIGS. 15A-15E and depicting the method of manufacturing the footwear.

FIGS. 17A-17C are perspective views of further articles incorporating the material element.

### DETAILED DESCRIPTION

The following discussion and accompanying figures disclose various configurations of a material element 10, methods for manufacturing material element 10, and various articles or products that incorporate material element 10.

### Material Element Configuration

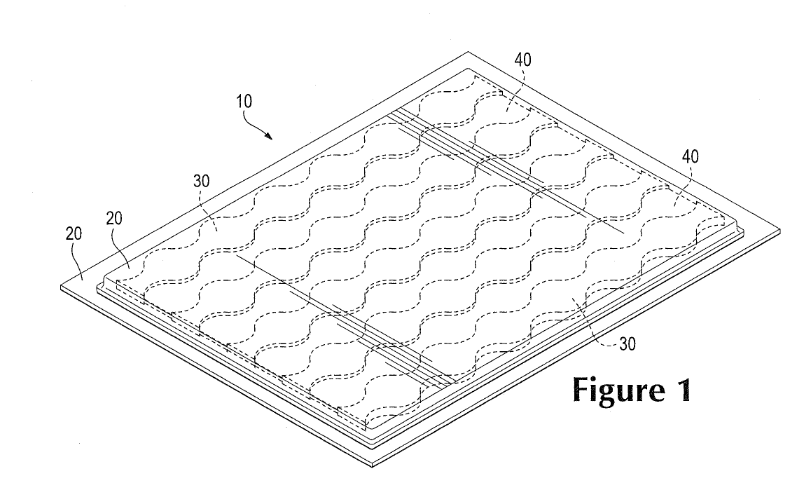

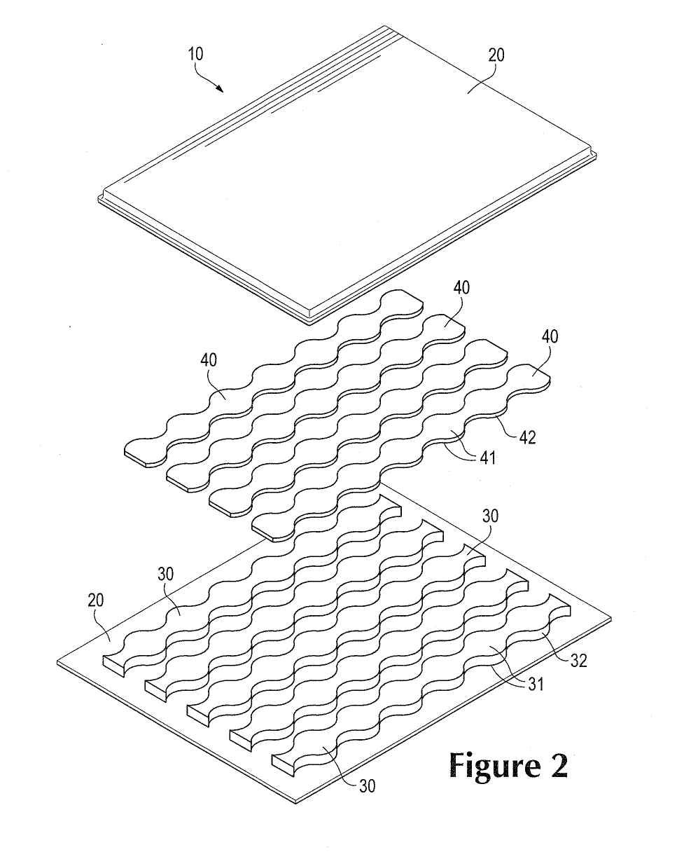

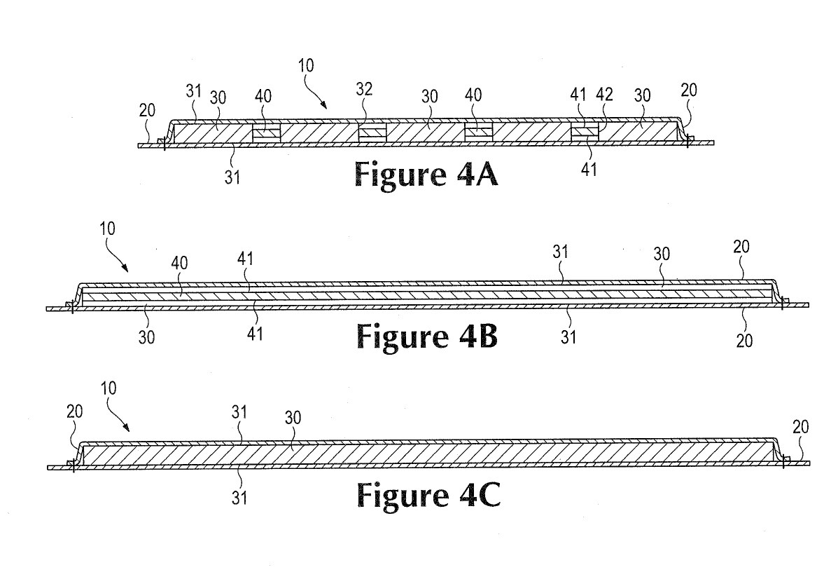

Material element 10 is depicted in FIGS. 1-4C as including a pair of cover layers 20, a plurality of first strip components 30, and a plurality of second strip components 40. In general, cover layers 20 cooperatively form an outer surface or covering for material element 10, and strip components 30 and 40 are positioned between cover layers 20. Although first strip components 30 are generally secured to each of cover layers 20, second strip components 40 may be unsecured to cover layers 20.

Cover layers 20 extend over opposite sides of strip components 30 and 40 and form a pocket or interior area in which strip components 30 and 40 are located. Although an edge area of one cover layer 20 is depicted as being joined to the other cover layer 20 (e.g. with stitching, adhesives, thermobonding) around a periphery of strip components 30 and 40 to form the pocket or interior area, cover layers 20 may be unjoined or may be joined in a different configuration. Each of cover layers 20 may be formed from a variety of materials, including textiles, polymer sheets, leather, or synthetic leather, for example. Although cover layers 20 may be formed from the same material, each of cover layers 20 may also be formed from different materials. Combinations of these materials may also be utilized for cover layers 20. For example, a polymer sheet may be bonded to a surface of a textile to form one of cover layers 20, or an edge of a textile may be secured to an edge of a polymer sheet to form one or cover layers 20. With regard to textiles, cover layers 20 may be formed from knitted, woven, or non-woven textile elements that include rayon, nylon, polyester, polyacrylic, cotton, wool, or silk, for example. Moreover, the textiles may be non-stretch, may exhibit one-directional stretch, may exhibit multi-directional stretch, or may have the configuration of a mesh or spacer-knit material. With regard to polymer sheets, cover layers 20 may be formed from thermoplastic or thermoset polymer materials, and the polymer sheets may be perforated or continuous. In some configurations, a variety of other materials may also be utilized as cover layers 20, including leather, synthetic leather, and a metallic mesh. Accordingly, a variety of materials are suitable for cover layers 20.

First strip components 30 are located between cover layers 20 and secured to each of cover layers 20. Moreover, first strip components 30 are substantially parallel to each other and spaced from each other, thereby forming gaps in which second strip components 40 are located. Although first strip components 30 are depicted as having a generally elongate and linear configuration that extends through substantially all of a length of material element 10, first strip components may be non-linear and may extend through only a portion of material element 10. Each of first strip components 30 has a pair of opposite securing surfaces 31 and an edge surface 32. Securing surfaces 31 are secured to cover layers 20 and exhibit a generally planar configuration. Edge surface 32 extends between securing surfaces 31 and exhibits an undulating, wavy, or otherwise non-linear configuration that defines various protrusions and depressions along the length and on opposite sides of first strip components 30.

Second strip components 40 are located between cover layers 20 and unsecured to each of cover layers 20. Moreover, second strip components 40 are substantially parallel to each other and spaced from each other, thereby forming gaps in which first strip components 30 are located. Although second strip components 40 are depicted as having a generally elongate and linear configuration that extends through substantially all of the length of material element 10, second strip components may be non-linear and may extend through only a portion of material element 10. Each of second strip components 40 has a pair of opposite surfaces 41 and an edge surface 42. Surfaces 41 are unsecured to cover layers 20 and exhibit a generally planar configuration. Edge surface 42 extends between surfaces 41 and exhibits an undulating, wavy, or otherwise non-linear configuration that defines various protrusions and depressions along the length and on opposite sides of second strip components 40.

Strip components 30 and 40 are depicted as having different thicknesses. More particularly, the thickness of first strip components 30 (i.e., the distance extending between cover layers 20 or the distance between securing surfaces 31) is greater than the thickness of second strip components 40 (i.e., the distance between surfaces 41). In this configuration, first strip components 30 space cover layers 20 from each other, and second strip components 40 may be spaced from each of cover layers 20 given their lesser thickness. Although second strip components 40 are depicted as being located centrally between cover layers 20, which forms spaces between surfaces 41 and cover layers 20, second strip components 40 may also lay against either of cover layers 20.

Edge surfaces 32 and 42 each exhibit undulating or wavy configuration, as discussed above. In general, the indentations and protrusions of edge surfaces 32 and 42 exhibit similar shapes and sizes. Given this configuration, edge surfaces 32 and 42 may contact each other and effectively mate with each other. That is, the protrusions of edge surface 32 may extend into the indentations of edge surface 42, and the protrusions of edge surface 42 may extend into the indentations of edge surface 32.

As discussed above, surfaces 41 of second strip components 40 are unsecured to cover layers 20. Moreover, strip components 30 and 40 are unsecured to each other. In this configuration, second strip components 40 are located within material element 10, but are unsecured or otherwise unattached to the other components of material element 10. The presence of cover layers 20 and the corresponding undulating configurations of edge surfaces 32 and 42, however, limit the movement of second strip components 40. Accordingly, although second strip components 40 are unsecured to cover layers 20 and first strip components 30, the positions of second strip components 40 are effectively fixed by the configuration of material element 10.

A variety of materials may be utilized for strip components 30 and 40, including various foamed polymer materials, non-foamed polymer materials, rubber, and silicone. Examples of suitable polymer materials (e.g., either foamed or non-foamed) for strip components 30 and 40 include polyurethane, ethylvinylacetate, polyester, polypropylene, and polyethylene foams. Moreover, both thermoplastic and thermoset polymer foam materials may be utilized. In some configurations of material element 10, strip components 30 and 40 may be formed from a polymer materials with varying densities. That is, first strip components may have a different density than second strip components 40. Also, strip components 30 and 40 may be formed from different materials. As an example, first strip components 30 may be formed from a foamed polymer material with a relatively low density, whereas second strip components 40 may be formed from a rubber material with a higher density. Accordingly, a variety of materials and combinations of materials may be utilized for strip components 30 and 40.

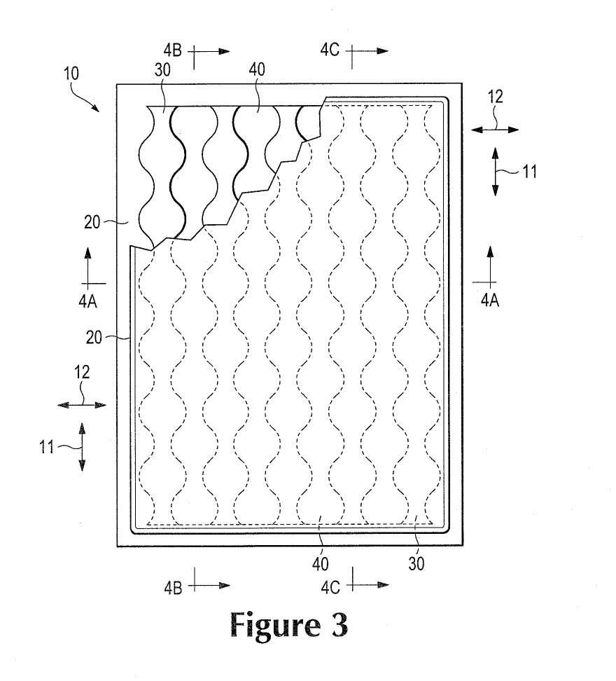

The configuration of material element 10 discussed above imparts various useful or otherwise advantageous features. As an example, material element 10 may exhibit different stretch characteristics in different directions. Referring to FIG. 3, various arrows 11 and 12 are depicted. Whereas arrows 11 are generally parallel to strip components 30 and 40, arrows 12 are generally perpendicular to strip components 30 and 40. Depending upon the materials selected for cover layers 20 and strip components 30 and 40, the stretch characteristics of material element 10 may be different in the directions of arrows 11 and arrows 12. In many configurations, for example, material element 10 will stretch to a greater degree in the direction of arrows 12 than in the direction of arrows 11. As another example, material elements 10 may attenuate impact forces to provide cushioning or protection. By selecting thicknesses, materials, and densities for each of the various strip components 30 and 40, the degree of impact force attenuation may be varied throughout material element to impart a desired degree of cushioning or protection. As further examples, material element 10 exhibits air-permeability (i.e., breathability), flexibility, and a relatively low overall mass.

### Further Material Element Configurations

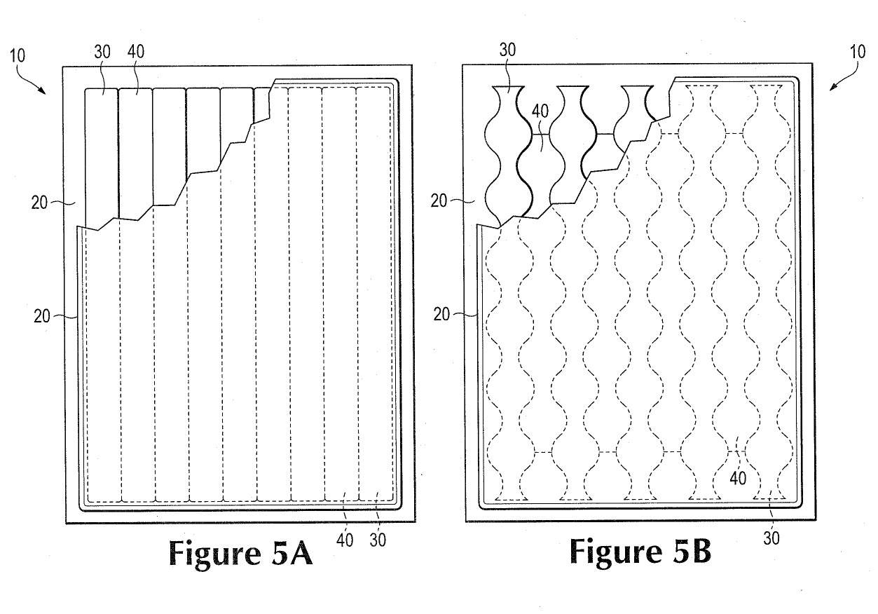

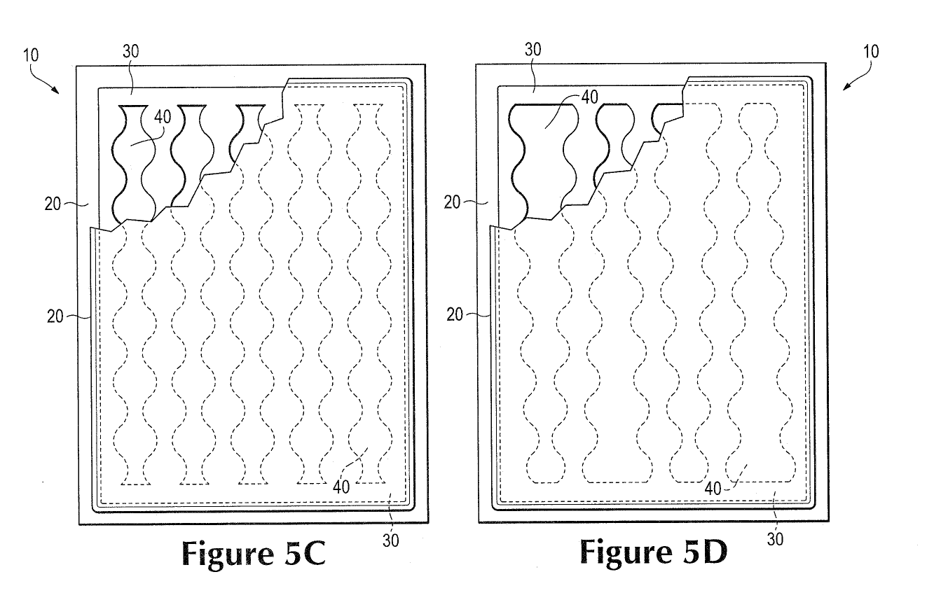

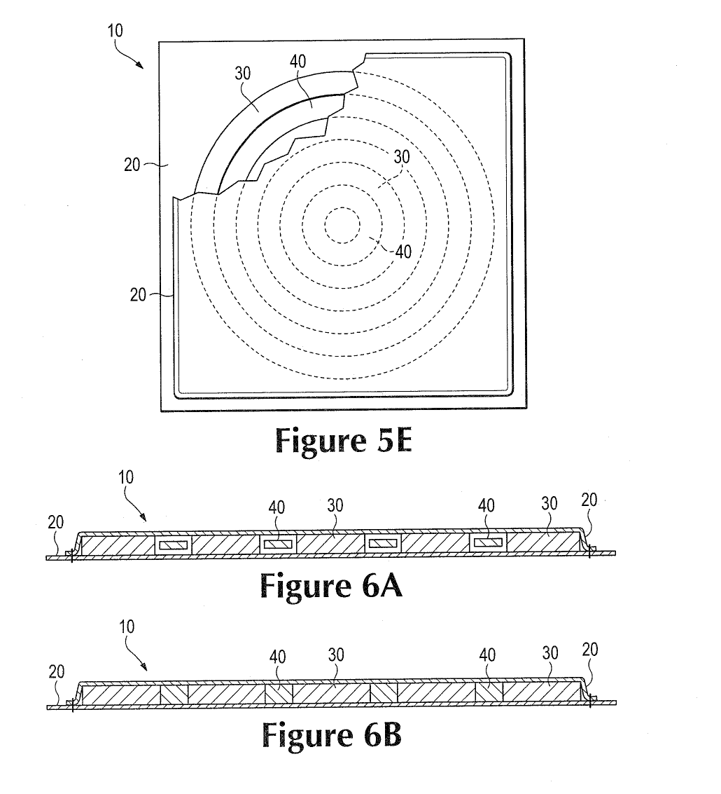

The overall configuration of material element 10 discussed above, including cover layers 20 and strip elements 30 and 40, is intended to provide an example of a suitable configuration for use in a variety of applications. Various aspects of material element 10 may vary considerably, as depicted in FIGS. 5A-5E. For example, FIG. 5A depicts a configuration wherein edge surfaces 32 and 42 exhibit a straight or otherwise non-undulating configuration that may permit strip elements 30 and 40 to slide or otherwise move relative to each other. The lengths of strip elements 30 and 40 may also vary, as depicted in FIG. 5B. In another configuration, as depicted in FIG. 5C, first strip elements 30 may have joined ends that effectively form a frame that receives second strip elements 40. That is, first strip elements 30 may be formed as a single element that defines apertures for receiving second strip elements 40. FIG. 5D depicts a configuration wherein first strip elements 30 have joined ends that form a frame with tapered apertures, and second strip elements 40 each have tapered configurations that fit within the apertures. Although strip elements 30 and 40 may be elongate and relatively straight, FIG. 5E depicts a configuration wherein strip elements 30 and 40 form concentric rings in material element 10.

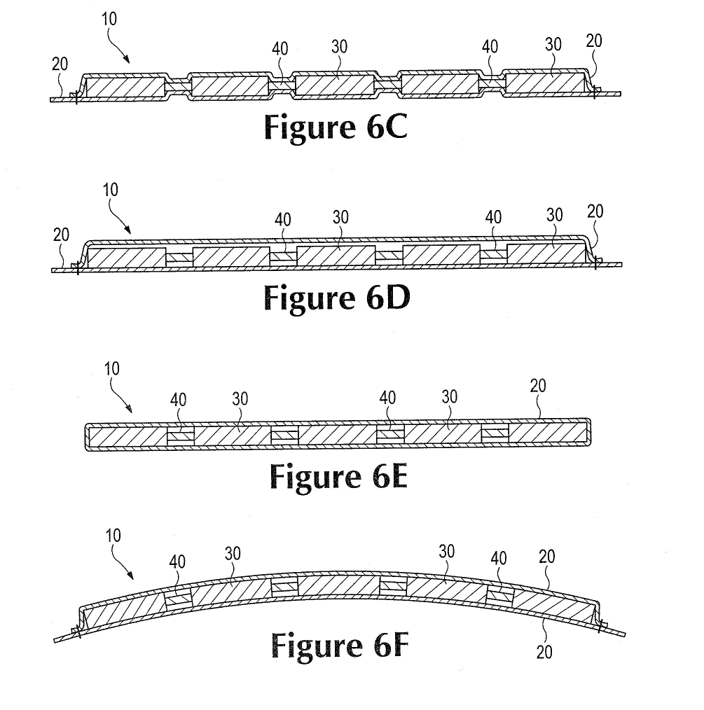

A variety of additional configurations for material element 10 are depicted in FIGS. 6A-6F. Edge surfaces 32 and 42 may contact each other to effectively form a continuous layer of polymer material within material element 10. Referring to FIG. 6A, however, strip elements 30 and 40 may be spaced from each other. In further configurations, strip elements 30 and 40 may have substantially equal thicknesses, as depicted in FIG. 6B. Although surfaces 42 of second strip elements 40 may be unsecured to cover layers 20, surfaces 42 may be secured to cover layers 20 in some configurations, as depicted in FIG. 6C. In another configuration, as depicted in FIG. 6D, first strip components 30 are only secured to one of cover layers 20. Referring to FIG. 6E, a single cover layer 20 wraps around strip components 30 and 40 and is secured to the opposite securing surfaces 31. Additionally, FIG. 6F depicts a configuration wherein material element 10 has a generally curved, rather than planar, aspect.

As discussed above, material element 10 exhibits various useful or otherwise advantageous features, including differing stretch characteristics, attenuation of impact forces, air-permeability, flexibility, and a relatively low overall mass. The various configurations depicted in FIGS. 5A-5E and 6A-6F may have an effect upon the various features. For example, the configuration of FIG. 5E may have similar stretch characteristics in all directions. Additionally, the configuration of FIG. 6A may impart greater air-permeability, whereas the configuration of FIG. 6B may enhance the attenuation of impact forces. Accordingly, by varying the configuration of material element 10, the advantageous features of material element 10 may be varied to meet requirements for a variety of applications.

### Manufacturing and Molding Processes

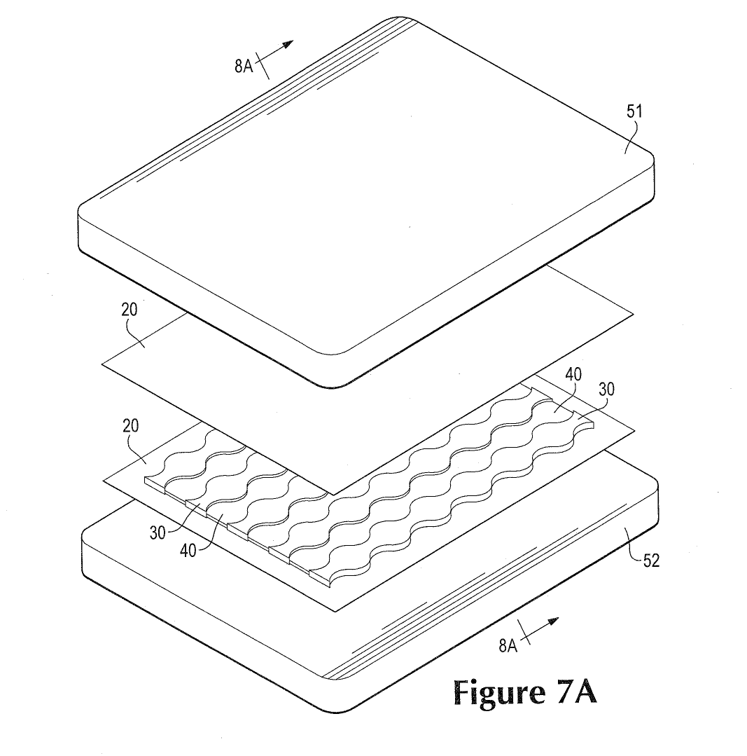

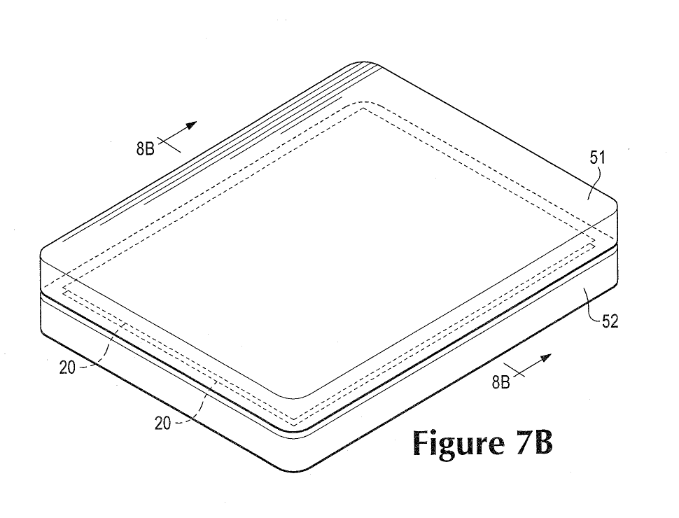

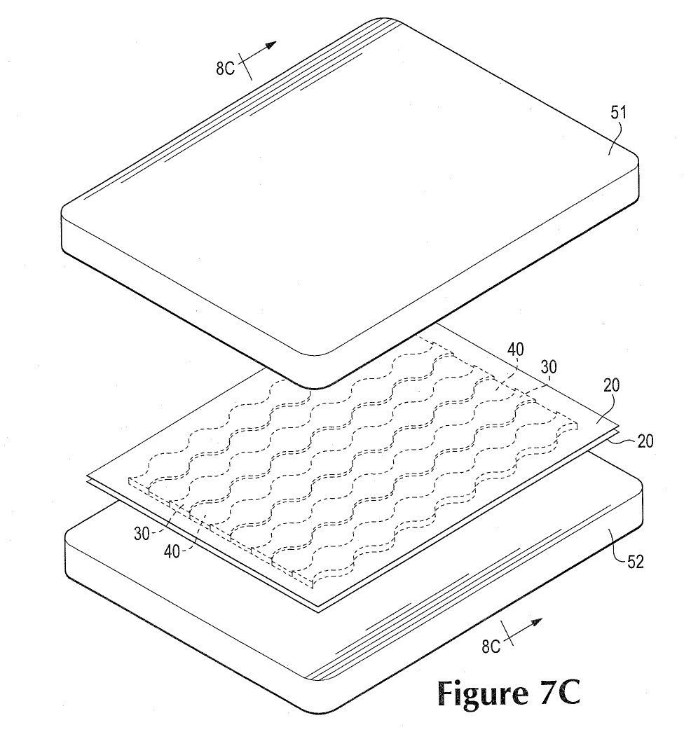

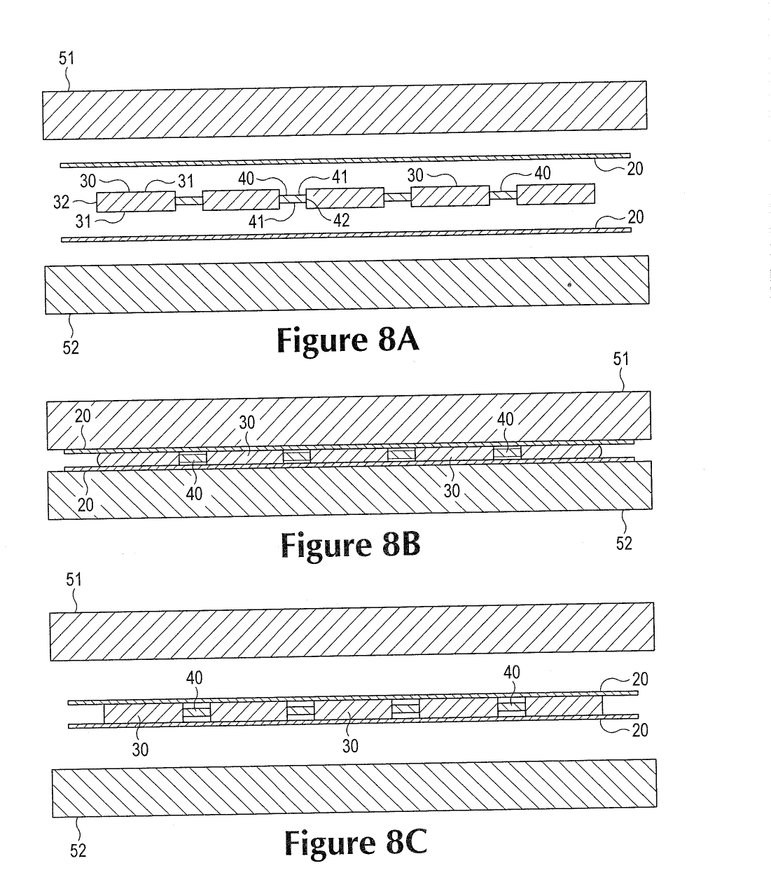

A variety of techniques may be utilized to manufacture material element 10. With reference to FIGS. 7A-7C and 8A-8C, an example of a suitable manufacturing process is discussed. Initially, the various components of material element 10 (i.e., cover layers 20 and strip components 30 and 40) are formed to have intended shapes and thicknesses through, for example, molding, die-cutting, or laser-cutting operations. Once formed, the components of material element 10 may be placed within a bonding apparatus having a first portion 51 and a second portion 52, as depicted in FIGS. 7A and 8A. Following proper positioning, portions 51 and 52 may close upon, compress, and heat cover layers 20 and strip components 30 and 40, as depicted in FIGS. 7B and 8B, to effect bonding between cover layers 20 and securing surfaces 31 of first strip components 30. In order to inhibit bonding between cover layers 20 and second strip components 40, the degree of compression between portions 51 and 52 may be carefully selected or a non-bonding material may be utilized for second strip components 40. A blocking material (e.g., polytetrafluoroethylene) may also be applied to surfaces 42 to inhibit bonding. Following compression and heating, portions 51 and 52 separate to expose material element 10, as depicted in FIGS. 7C and 8C. Additional stitching, adhesive, or thermal bonding steps may now be utilized to join cover layers 20 around the periphery of strip components 30 and 40.

When compressed between portions 51 and 52, heat from portions 51 and 52 may be utilized to bond cover layers 20 to securing surfaces 31. A thermoplastic polymer material melts when heated and returns to a solid state when cooled sufficiently. Based upon this property of thermoplastic polymer materials, thermobonding processes may be utilized to form a thermobond that joins cover layers 20 to securing surfaces 31. As utilized herein, the term “thermobonding” or variants thereof is defined as a securing technique between two elements that involves a softening or melting of a thermoplastic polymer material within at least one of the elements such that the materials of the elements are secured to each other when cooled. Similarly, the term “thermobond” or variants thereof is defined as the bond, link, or structure that joins two elements through a process that involves a softening or melting of a thermoplastic polymer material within at least one of the elements such that the materials of the elements are secured to each other when cooled. As examples, thermobonding may involve (a) the melting or softening of thermoplastic materials within cover layers 20 and first strip components 30 that joins the elements together, (b) the melting or softening of a thermoplastic material within first strip components 30 such that the thermoplastic polymer material extends into or infiltrates the structure of a textile utilized for cover layers 20, or (c) the melting or softening of a thermoplastic material within cover layers 20 such that the thermoplastic polymer material extends into or infiltrates the structure of first strip components 30. Thermobonding may occur when only one element includes a thermoplastic polymer material or when both elements include thermoplastic polymer materials. Additionally, thermobonding does not generally involve the use of stitching or adhesives, but involves directly bonding elements to each other with heat. In some situations, however, stitching or adhesives may be utilized to supplement the thermobond or the joining of elements through thermobonding.

At this stage, material element 10 has the general configuration depicted in FIGS. 1-4C. Depending upon the application in which material element 10 is utilized, however, a curved or otherwise non-planar configuration may be advantageous, as depicted in FIG. 6F. Depending upon the materials selected for cover layers 20 and strip components 30 and 40, the application of heat and pressure may be sufficient to impart curvature or other three-dimensional features to material element 10. For example, when one or both of strip components 30 and 40 incorporate a thermoplastic material, heating and molding of material element 10, followed by cooling, may impart the curvature or other three-dimensional features.

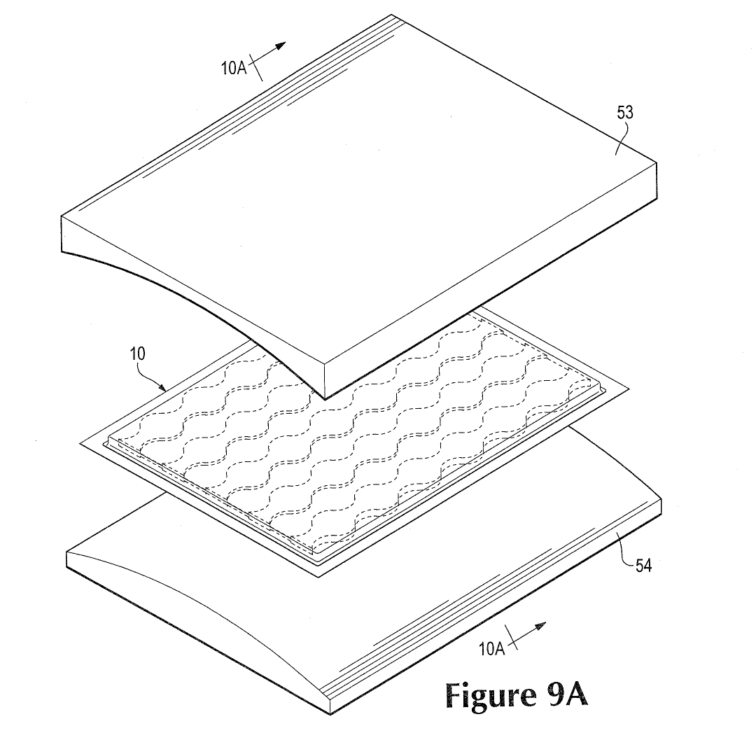

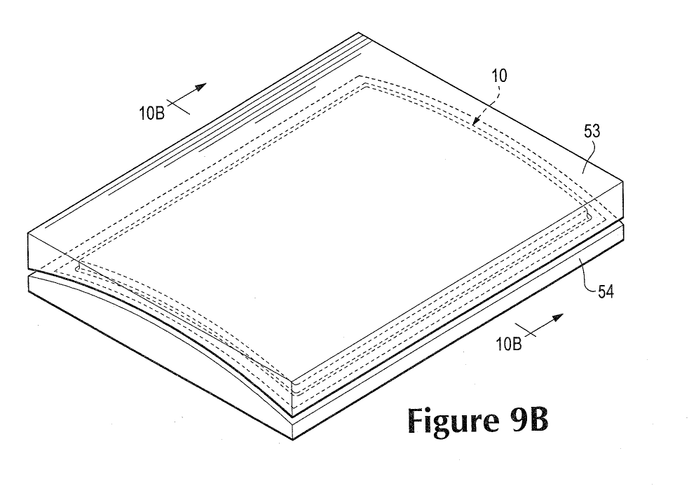

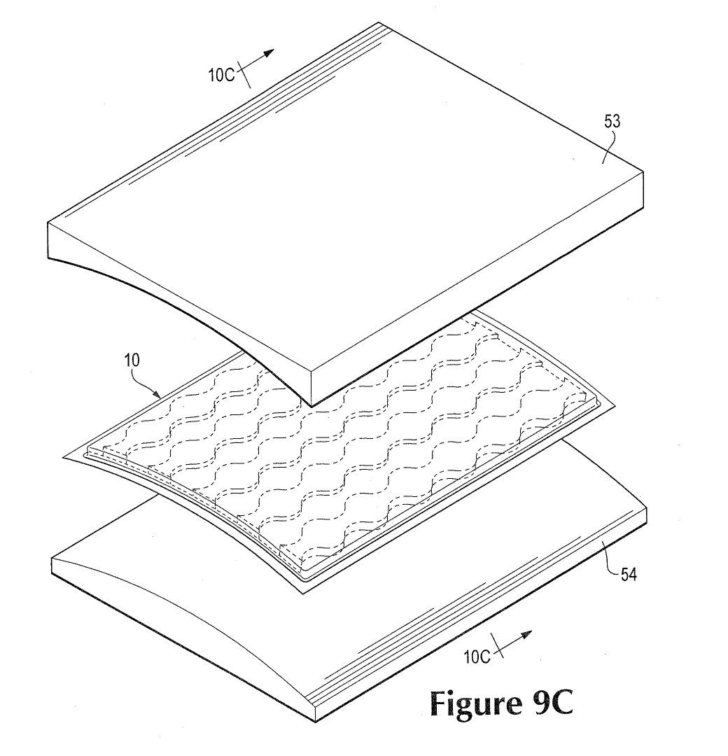

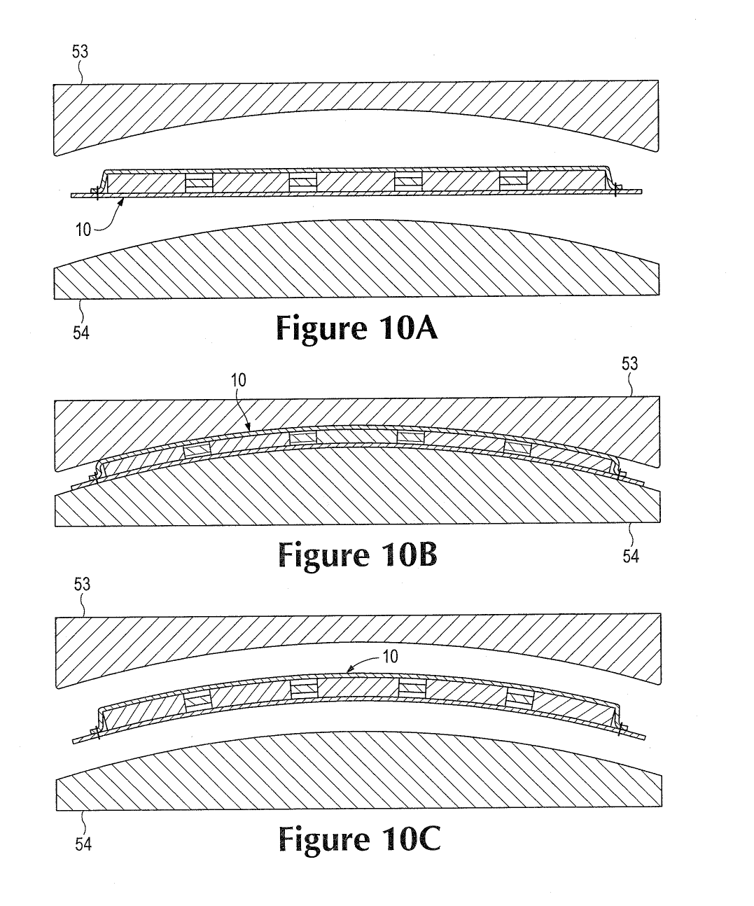

A variety of techniques may be utilized to mold or otherwise shape material element 10 to impart curvature or other three-dimensional features. With reference to FIGS. 9A-9C and 10A-10C, an example of a suitable molding process is discussed. Initially, material element 10 (i.e., as formed in the manner discussed above) may be placed within a molding apparatus having a first portion 53 and a second portion 54, as depicted in FIGS. 9A and 10A. Following proper positioning, portions 53 and 54 may close upon, compress, and heat cover layers 20 and strip components 30 and 40, as depicted in FIGS. 9B and 10B. Given that a molding surface of first portion 53 has a concave configuration and a molding surface of second portion 54 has a corresponding convex configuration, the molding apparatus effectively imparts a curved configuration to material element 10. Following compression and heating, portions 53 and 54 separate to expose a curved material element 10, as depicted in FIGS. 9C and 10C. Accordingly, the application of heat and pressure may be utilized to impart curvature or other three-dimensional features to material element 10.

The curvature of material element 10 depicted in FIGS. 6F, 9C, and 10C is oriented in a direction that is perpendicular to the lengths of strip components 30 and 40. Depending upon the manner in which material element 10 is oriented in the molding apparatus, however, curvature may also be imparted to a direction corresponding with the lengths of strip components 30 and 40. Moreover, multi-curved structures having an S-shaped, sinusoidal, or wavy configuration may be formed, as well as curvatures extending in multiple directions (e.g., indentations and protrusions). In effect, therefore, material element 10 may be molded to exhibit a variety of shapes.

### Apparel Configurations

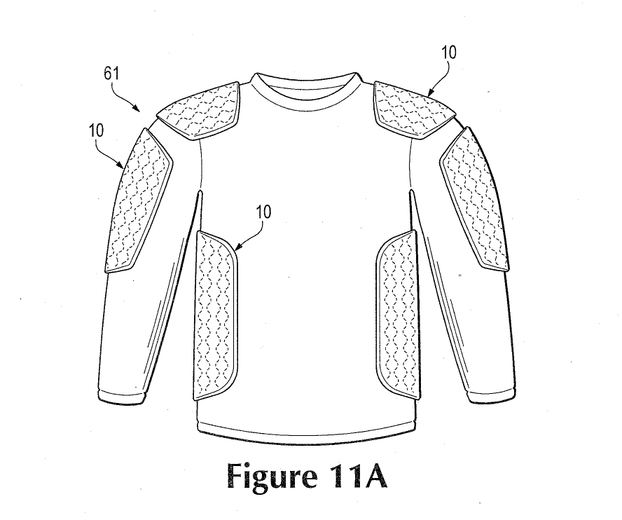

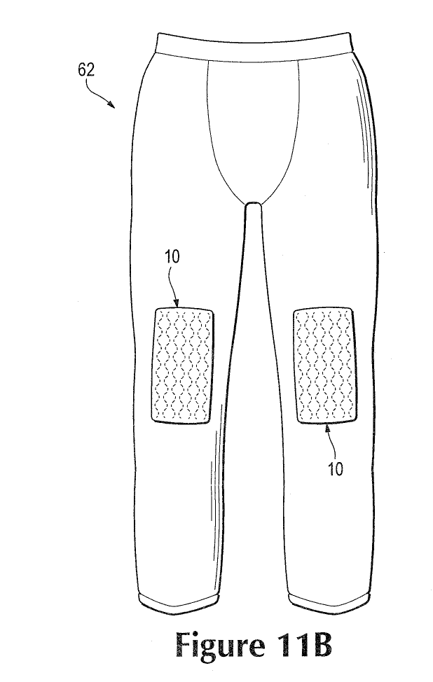

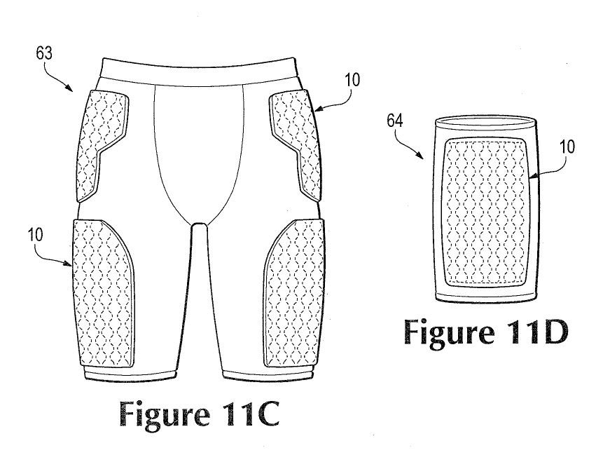

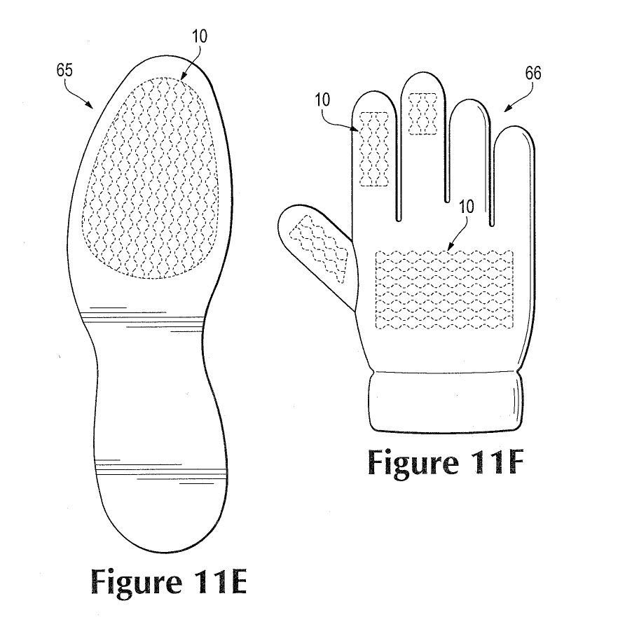

Material element 10 that may be incorporated into a variety of products, including various articles of apparel. In addition to attenuating impact forces, material elements 10 may also simultaneously provide one or more of stretch, air-permeability, flexibility, and a relatively low overall mass to the apparel. Additionally, material elements 10 may be molded to conform with a shape of a wearer of the apparel. As an example, a shirt 61 is depicted in FIG. 11A as including six material elements 10 in locations that correspond with elbows, shoulders, and sides of a wearer. When worn, material elements 10 may provide protection to each of the elbows, shoulders, and sides. That is, material elements 10 may attenuate impact forces upon the elbows, shoulders, and sides. Although shirt 61 is depicted as a long-sleeved shirt, shirt 61 may have the configuration of other shirt-type garments, including short-sleeved shirts, tank tops, undershirts, jackets, and coats, for example.

A variety of techniques may be utilized to incorporate material elements 10 into shirt 61. As an example, material elements 10 may be stitched or otherwise bonded to other materials forming shirt 61. In some configurations, material elements 10 may have the configuration depicted in FIG. 1, wherein (a) the lower cover layer 20 extends outward beyond the periphery of strip components 30 and 40 and (b) the upper cover element 20 is stitched around the periphery of strip components 30 and 40 to form a portion of an exterior surface of shirt 61. In this configuration, the lower cover layer 20 may be part of a larger material element that forms portions of shirt 61. That is, the lower cover layer 20 may form the interior surface of shirt 61, as well as the exterior surface in areas where material elements 10 are absent. Accordingly, the manner in which material elements 10 are incorporated into shirt 61 may vary.

Shirt 61 may be intended for use as a compression garment. In addition to therapeutic uses, compression garments are often worn by athletes as a base layer under jerseys or other athletic apparel. In general, compression garments or other garments intended as base layers (a) exhibit a relatively tight fit that lays adjacent to the skin of the wearer and (b) stretch to conform with the contours of the wearer. While the textile materials forming compression garments may have one-directional stretch of, for example, more than ten percent prior to tensile failure, the textile materials forming other compression garments have two-directional stretch of at least thirty percent prior to tensile failure. Accordingly, when shirt 61 is formed to have a relatively tight fit and to stretch to conform with the contours of the wearer, the textile materials forming shirt 61 may have two-directional stretch of at least thirty percent prior to tensile failure. Moreover, an advantage to forming shirt 61 to be a compression garment is that material elements 10 are located immediately adjacent to the skin of the wearer and the tighter materials cause material elements 10 to flex to the shape of the wearer.

Referring to FIG. 11B, a pair of pants 62 is depicted as including material elements 10 in locations that correspond with knees of a wearer. When worn, material elements 10 may provide protection to the knees. In addition to being located in knee regions of a garment, material elements 10 may also be located in other areas. Referring to FIG. 11C, a pair of shorts 63 is depicted as having four material elements 10 in hip and thigh areas. As with shirt 61, shorts 63 be intended for use as a compression garment.

In addition to shirt-type garments and pants-type garments, material elements 10 may be incorporated into garments that cover other areas of the wearer, such as hats, helmets, wraps, footwear, socks, and gloves, for example. As an example, a wrap 64 having one material element 10 is depicted in FIG. 11D. Wrap 64 has a generally cylindrical configuration that may be placed upon an arm or a leg of a wearer. When, for example, the wearer's elbow is sore or injured, material element 10 may be located over the elbow to assist with protecting the elbow during athletic activities. As another example, a sockliner 65 at least partially formed from material element 10 is depicted in FIG. 11E. Sockliner 65 may be located within an article of footwear to cushion a lower (i.e., plantar) surface of the foot. Additionally, one or more material elements 10 may be incorporated into a glove 66, as depicted in FIG. 11F, to impart protection to a hand of the wearer (i.e., attenuate impact forces).

### Footwear Configuration

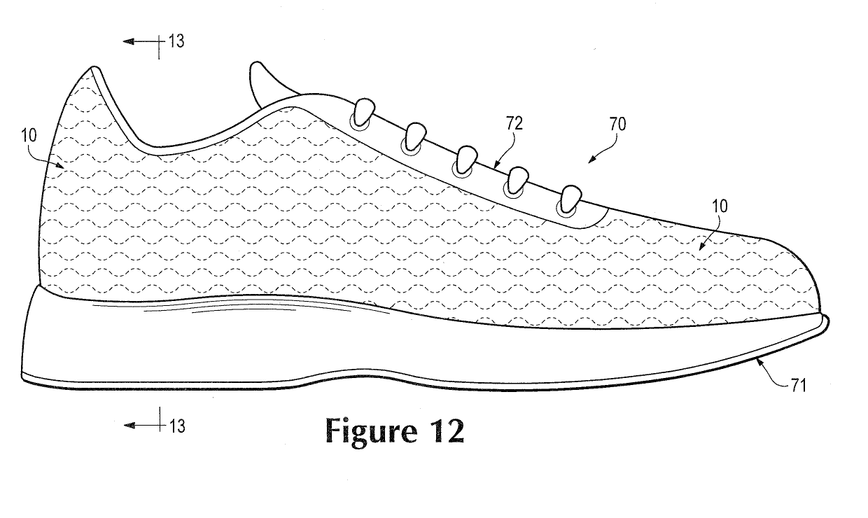

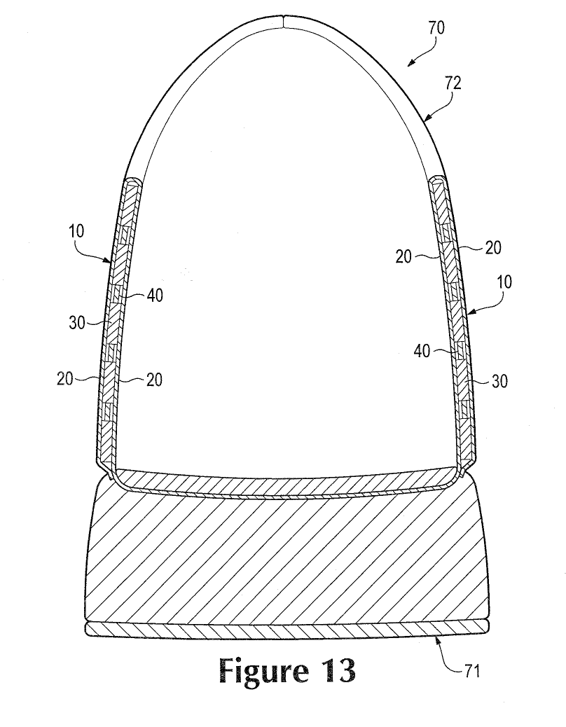

An article of footwear 70, which is an example of another article of apparel, is depicted in FIGS. 12 and 13 as including a sole structure 71 and an upper 72. As discussed in greater detail below, upper 72 incorporates material element 10. Although footwear 70 is depicted as having a configuration that is suitable for running, material element 10 may be incorporated into a wide range of athletic footwear styles, including basketball shoes, biking shoes, cross-training shoes, football shoes, golf shoes, hiking shoes and boots, ski and snowboarding boots, soccer shoes, tennis shoes, and walking shoes, for example. Concepts associated with material element 10 may also be utilized with footwear styles that are generally considered to be non-athletic, including dress shoes, loafers, and sandals. Accordingly, material element 10 may be incorporated into a wide variety of footwear styles.

Sole structure 71 is secured to upper 72 and extends between the foot and the ground when footwear 70 is worn. In general, sole structure 71 may have any conventional or non-conventional configuration. Upper 72 provides a structure for securely and comfortably receiving a foot. More particularly, the various elements of upper 72, including material element 10, generally define a void within footwear 70 for receiving and securing the foot relative to sole structure 71. Surfaces of the void within upper 72 are shaped to accommodate the foot and extend over the instep and toe areas of the foot, along the medial and lateral sides of the foot, under the foot, and around the heel area of the foot. A majority of upper 72 may be formed from material element 10. Referring to FIG. 13, for example, material element 10 forms a portion of an exterior surface of upper 72, as well as an opposite interior surface of upper 72 (i.e., the surface defining the void within upper 30).

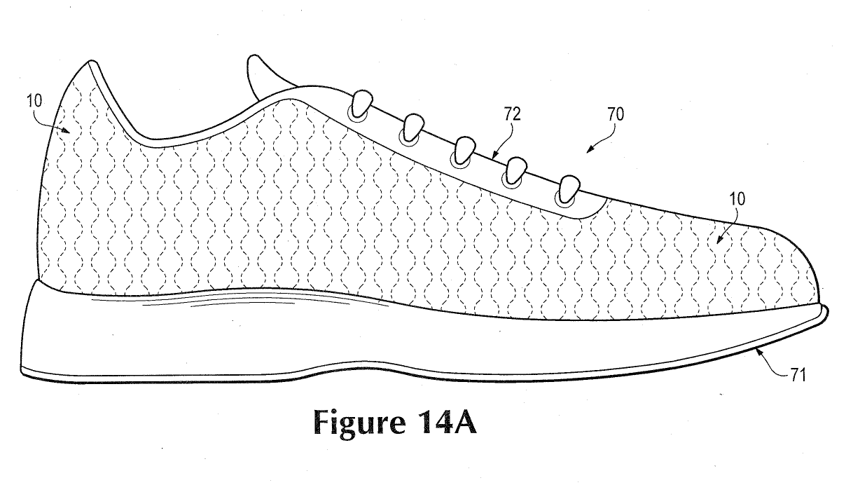

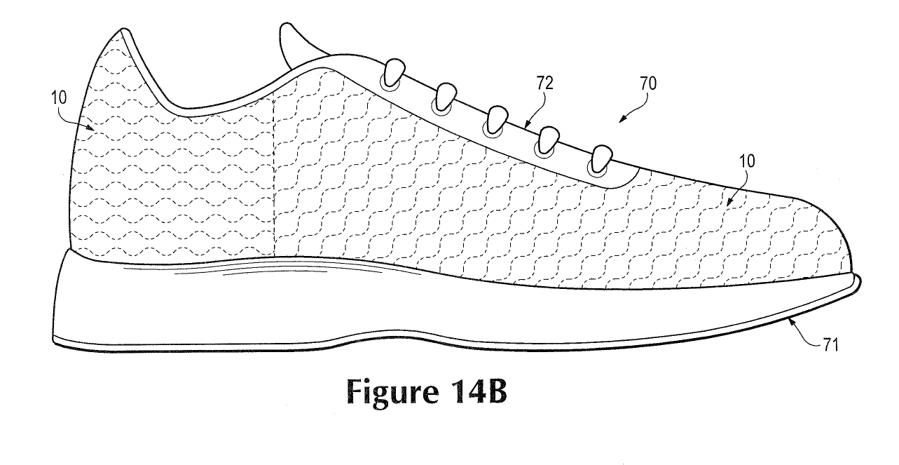

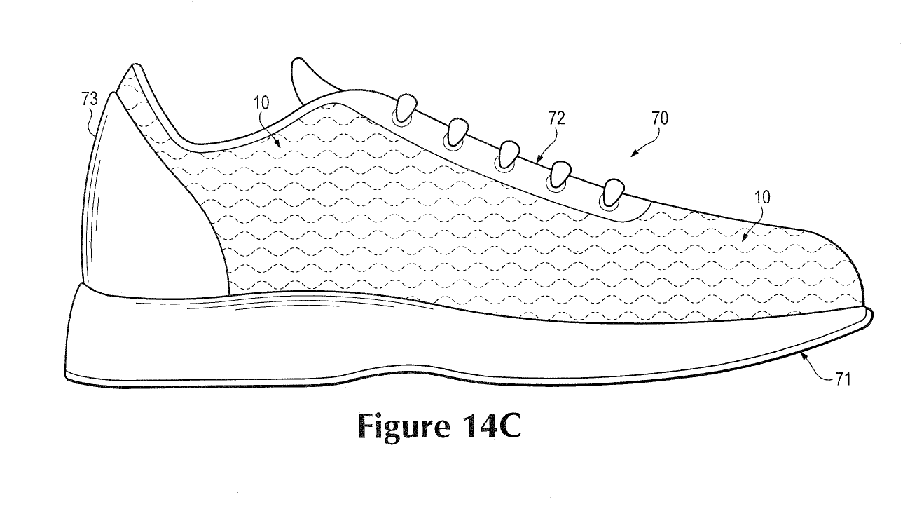

Strip components 30 and 40 may be aligned to extend longitudinally from a heel region to a forefoot region of footwear 70, as depicted in FIG. 12. In further configurations, however, strip components 30 and 40 may extend in other directions. Referring to FIG. 14A, for example, strip components 30 and 40 extend vertically. In another configuration, depicted in FIG. 14B, strip components 30 and 40 extend (a) horizontally in the heel region and (b) diagonally in midfoot and forefoot regions of footwear 70. The orientation of strip components 30 and 40 may, therefore, vary considerably. Additionally, other elements, such as a heel counter 73 may extend over areas of material element 10, as depicted in FIG. 14C. Accordingly, the manner in which material element 10 is incorporated into footwear 70 and utilized in combination with other portions of footwear 70 may vary.

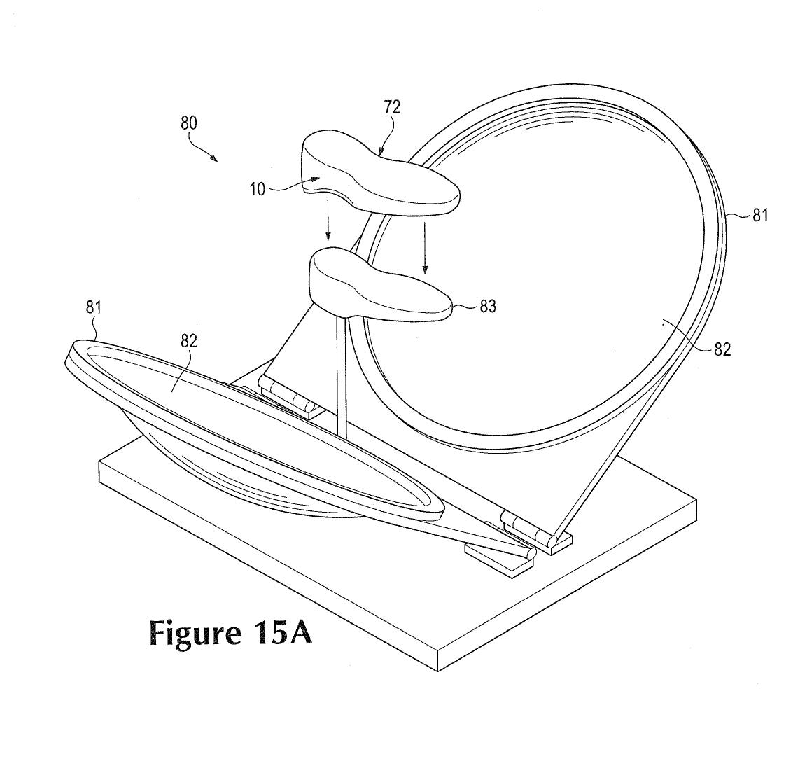

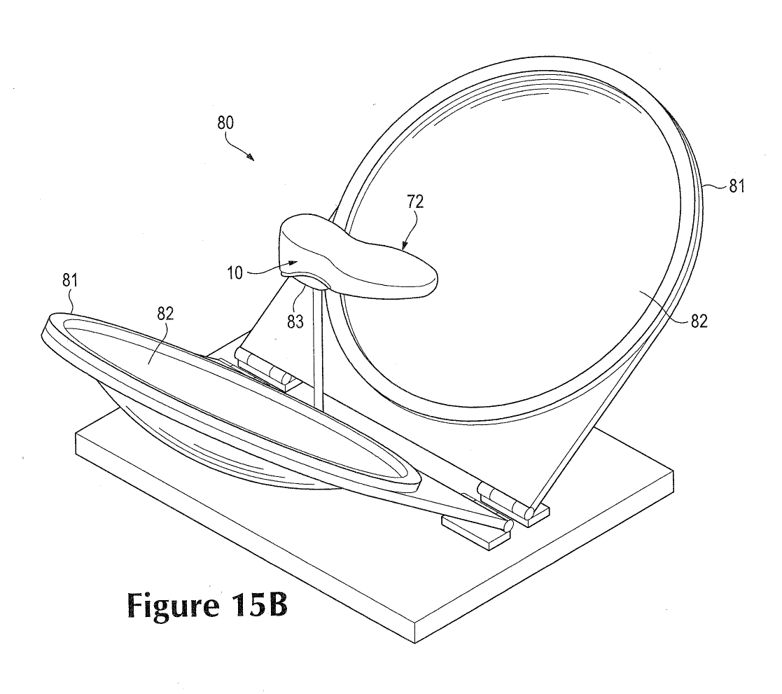

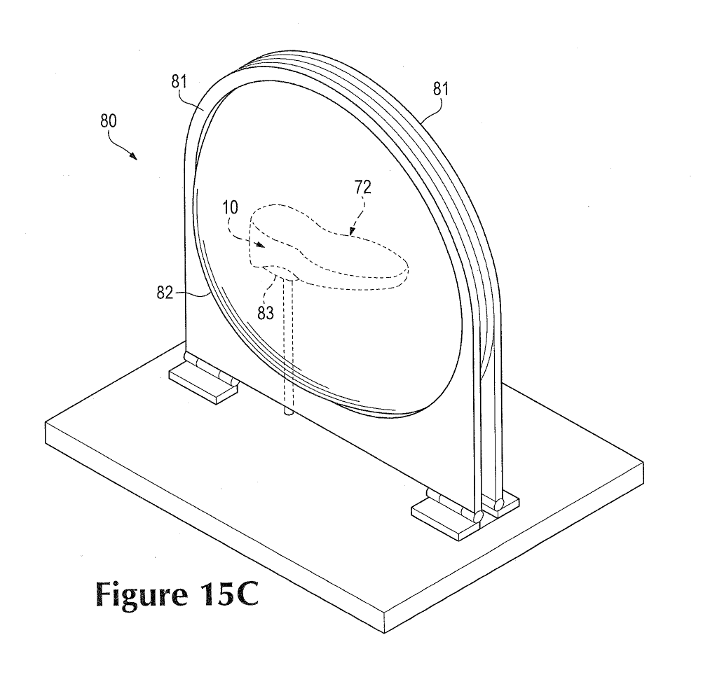

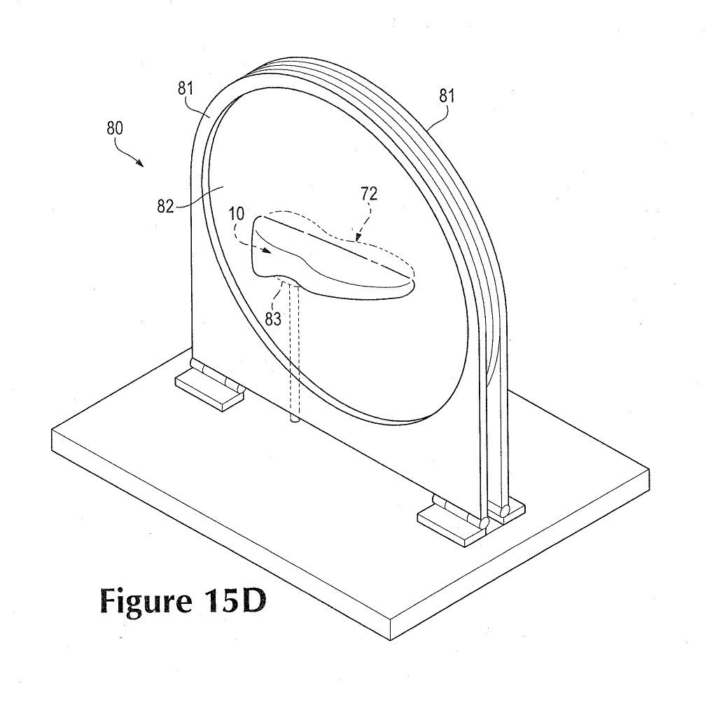

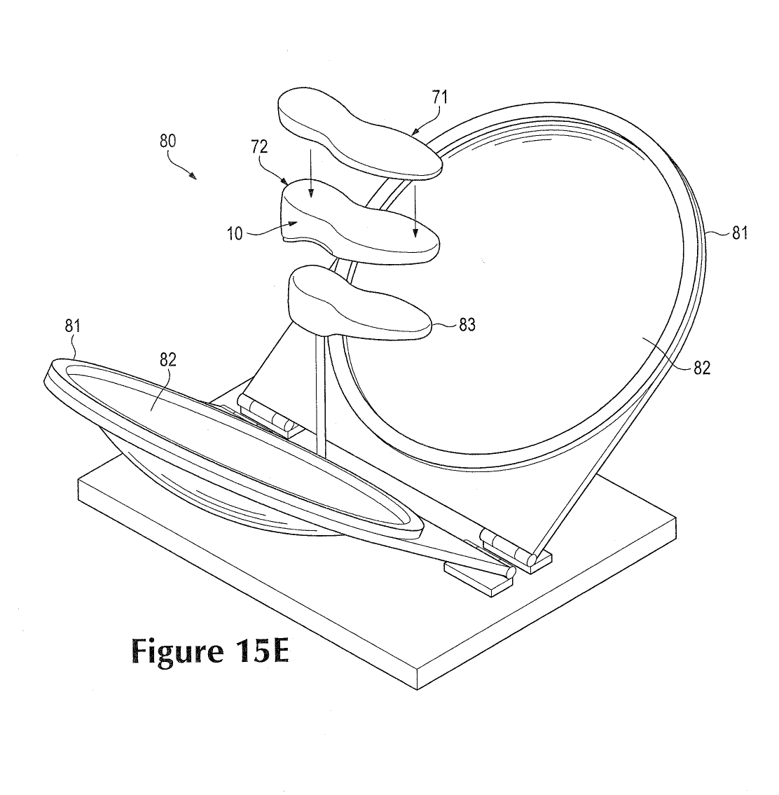

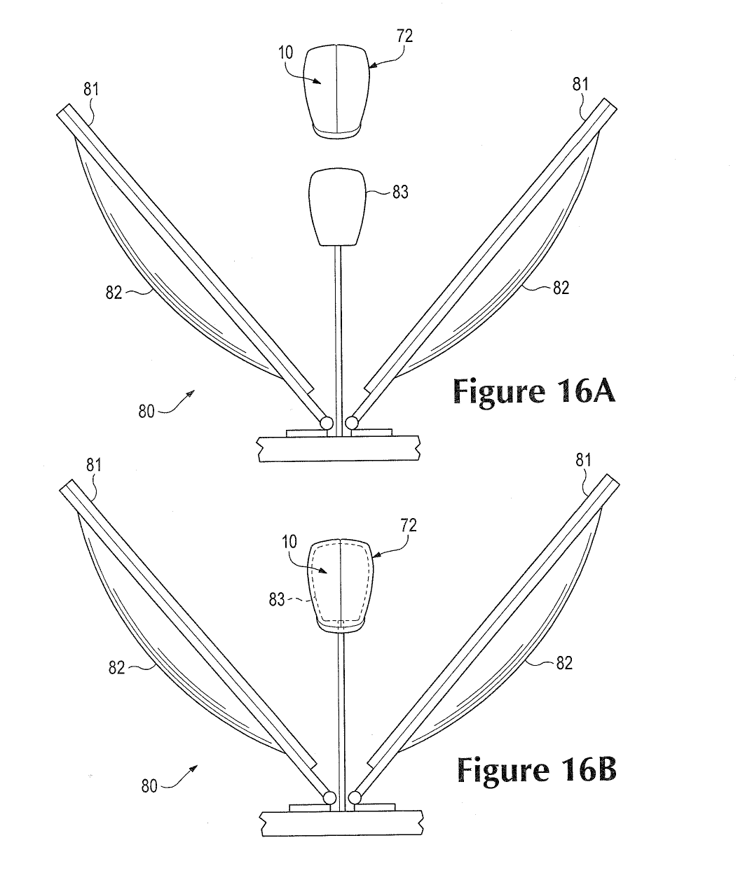

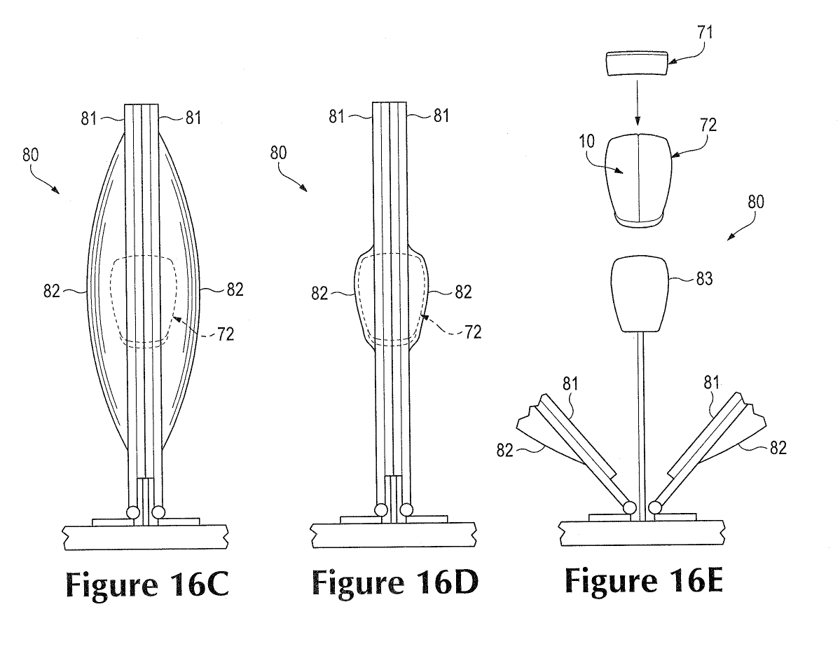

Material element 10 may merely be incorporated (i.e., stitched or bonded) into footwear 70. An advantage of material element 10, however, relates to the moldability. More particularly, material element 10 may be molded to conform with a shape of a foot, thereby enhancing the fit and overall comfort of footwear 70. Referring to FIGS. 15A and 16A, upper 72 is depicted as being located outside of a molding apparatus 80 having the general configuration of an assembly disclosed in U.S. patent application Ser. No. 12/245,402, which is entitled Method Of Customizing An Article And Apparatus and was filed in the U.S. Patent and Trademark Office on 3 Oct. 2008, such application being entirely incorporated herein by reference. Molding apparatus 80 includes a pair of elliptical frames 81 and a pair of membranes 82 located within frames 81. In addition, molding apparatus 80 includes a last 83 that is supported between frames 81 and membranes 82. In general, last 83 has a shape of a foot and is sized to extend into the void within upper 72.

At this stage of the process, (a) sole structure 71 is not yet secured to upper 72 and (b) upper 72 is formed to include material element 10, but upper 72 is not molded to have a shape that conforms with a shape of the foot. Upper 72 is then located on last 83, as depicted in FIGS. 15B and 16B. More particularly, last 83 is placed into the void within upper 72. Molding apparatus 80 then closes around upper 72, as depicted in FIGS. 15C and 16C, such that frames 81 extend around upper 72 and membranes 82 are located on opposite sides of upper 72. A vacuum system then at least partially evacuates air from the area between membranes 82 to induce membranes 82 to contact and compress upper 72 against last 83, as depicted in FIGS. 15D and 16D. More particularly, the differential in pressure between the area within molding apparatus 80 and the area exterior of molding apparatus 80 causes membranes 82 to compress against the exterior surface of upper 72. Additionally, the area within molding apparatus 80 is heated to elevate the temperature of material element 10. As with the method of molding material element 10 discussed above (i.e., in conjunction with FIGS. 9A-9C and 10A-10C), the application of heat and pressure induces material element 10 to conform with last 83. In effect, therefore, molding apparatus 80 molds upper 72 to have the shape of a foot. Once molding is complete, molding apparatus 80 opens and sole structure 71 is secured to upper 72, as depicted in FIGS. 15E and 16E. In some processes, sole structure 71 may be secured to upper 72 prior to molding within molding apparatus 80.

Based upon the above discussion, the method of manufacturing footwear 70 generally includes forming material element 10 by locating a plurality strip components 30 and 40 between cover layers 20, with each of strip components 30 and 40 having a planar configuration. Material element 10 is incorporated into upper 72, which is placed around last 83. Heat and pressure are applied to material element 10 to (a) compress strip components 30 and 40 and cover layers 20 against an exterior surface of last 83 and (b) mold strip components 30 and 40 and cover layers 20 to have a non-planar configuration that corresponds with a shape of the exterior surface of last 83.

### Further Product Configurations

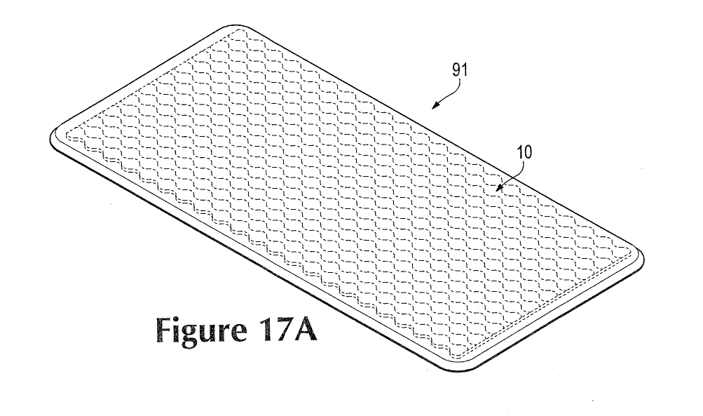

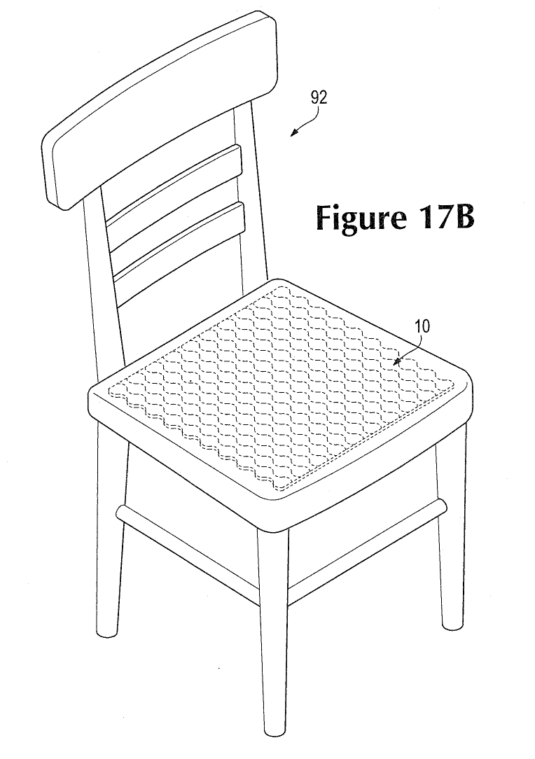

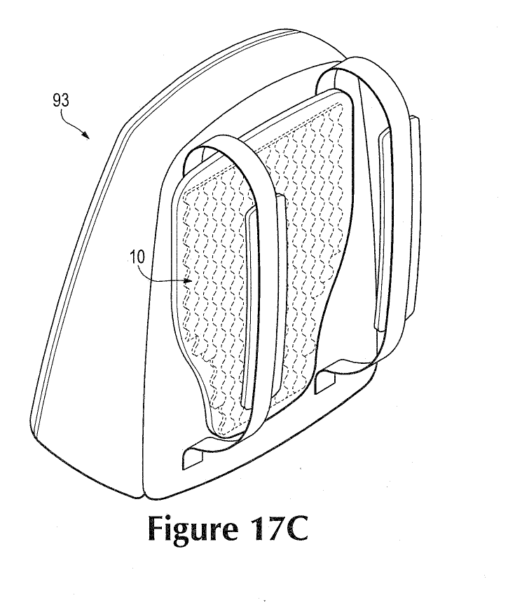

Material elements 10 may be utilized in products other than apparel (e.g., shirts, pants, gloves, footwear). Referring to FIG. 17A, a mat 91 is depicted as being primarily formed from material element 10. Mat 91 may be utilized, for example, during yoga or as a camping pad to provide a comfortable surface for sitting or lying on the ground. Material element 10 may also be incorporated into a chair 92, as depicted in FIG. 17B, to provide a comfortable place to sit. Similarly, material element 10 may be incorporated into a cushion that may be placed upon a chair or upon bleachers at a sporting event, for example. Also, material element 10 may be incorporated into a backpack 93, as depicted in FIG. 17C, to provide cushioning against the back of the wearer. Accordingly, various configurations of material element 10 may be incorporated into a plurality of products.

The invention is disclosed above and in the accompanying figures with reference to a variety of configurations. The purpose served by the disclosure, however, is to provide an example of the various features and concepts related to the invention, not to limit the scope of the invention. One skilled in the relevant art will recognize that numerous variations and modifications may be made to the configurations described above without departing from the scope of the present invention, as defined by the appended claims.

1. A material element comprising:
a first cover layer and a second cover layer;
a plurality of first strip components located between the first cover layer and the second cover layer, the first strip components being secured to the first cover layer and the second cover layer, and portions of the first strip components being spaced from each other; and
a plurality of second strip components located between the first cover layer and the second cover layer, the second strip components being unsecured to the first cover layer and the second cover layer, and the second strip components being positioned between the first strip components.

2. The material element recited in claim 1, wherein a thickness of the first strip components is greater than a thickness of the second strip components.

3. The material element recited in claim 1, wherein each of the first strip components and the second strip components have edges with an undulating configuration.

4. The material element recited in claim 1, wherein the first strip components are formed from a polymer foam material.

5. The material element recited in claim 4, wherein the second strip components are formed from a material with a greater density than the polymer foam material.

6. The material element recited in claim 1, wherein the first strip components are formed from a thermoplastic polymer foam material that is thermobonded to the first cover layer and the second cover layer.

7. The material element recited in claim 1, wherein at least one of the first cover layer and the second cover layer are formed from a textile.

8. The material element recited in claim 1, wherein end areas of the first strip components are joined to each other.

9. The material element recited in claim 1, wherein the material element is incorporated into an article of apparel.

10. The material element recited in claim 9, wherein the article of apparel is footwear.

11. A material element comprising:
a first cover layer and a second cover layer, at least one of the first cover layer and the second cover layer being formed from a textile;
a plurality of first strip components located between the first cover layer and the second cover layer and formed from a polymer foam material, the first strip components being secured to the first cover layer and the second cover layer, edges of the first strip components having a non-linear configuration, and the first strip components having a first thickness in a direction extending from the first cover layer to the second cover layer; and
a plurality of second strip components located between the first cover layer and the second cover layer and formed from a polymer material, the second strip components being unsecured to the first cover layer and the second cover layer, the second strip components being positioned between the first strip components, edges of the second strip components having a non-linear configuration that mates with the edges of the first strip components, and the second strip components having a second thickness in the direction extending from the first cover layer to the second cover layer, the first thickness being greater than the second thickness.

12. The material element recited in claim 11, wherein the polymer foam material of the first strip components is a thermoplastic polymer foam material, and the first strip components are thermobonded to the first cover layer and the second cover layer.

13. The material element recited in claim 11, wherein the polymer foam material of the first strip components has a lesser density than the polymer material of the second strip components.

14. The material element recited in claim 11, wherein end areas of the first strip components are joined to each other.

15. The material element recited in claim 11, wherein the material element is incorporated into an article of apparel.

16. An article of apparel comprising:
a first cover layer and a second cover layer, the first cover layer forming at least a portion of an exterior surface of the apparel;
a plurality of first strip components located between the first cover layer and the second cover layer, the first strip components being secured to the first cover layer and the second cover layer, and the first strip components being formed from a polymer foam material; and
a plurality of second strip components located between (a) the first cover layer and the second cover layer and (b) the first strip components, the second strip components being unsecured to the first cover layer and the second cover layer, and the second strip components being formed from a polymer material.

17. The article of apparel recited in claim 16, wherein the second cover layer forms at least a portion of an interior surface of the apparel.

18. The article of apparel recited in claim 16, wherein a thickness of the first strip components is greater than a thickness of the second strip components.

19. The article of apparel recited in claim 16, wherein each of the first strip components and the second strip components have edges with a non-linear configuration.

20. The article of apparel recited in claim 16, wherein the polymer foam material of the first strip components has a lesser density than the polymer material of the second strip components.

21. The article of apparel recited in claim 16, wherein the polymer foam material of the first strip components is a thermoplastic polymer foam material that is thermobonded to the first cover layer and the second cover layer.

22. An article of apparel comprising:
a first cover layer and a second cover layer; and
a plurality of elongate strip components located between the first cover layer and the second cover layer, edges of the strip components having non-linear configurations that mate with each other, at least a portion of the strip components incorporating a thermoplastic polymer material that is thermobonded to the first cover layer and the second cover layer.

23. The article of apparel recited in claim 22, wherein the first cover layer forms at least a portion of an exterior surface of the apparel.

24. The article of apparel recited in claim 23, wherein the second cover layer forms at least a portion of an interior surface of the apparel.

25. The article of apparel recited in claim 22, wherein a first portion of the strip components has a first thickness and a second portion of the strip components has a second thickness, the first thickness being greater than the second thickness.

26. The article of apparel recited in claim 25, wherein the first portion of the strip components has a first density and the second portion of the strip components has a second density, the first density being less than the second density.

27. The article of apparel recited in claim 22, wherein at least one of the first cover layer and the second cover layer are formed from a textile.

28. A method of manufacturing an article of apparel having a configuration of footwear, the method comprising:
locating a plurality polymer strip components between a pair of cover layers, each of the strip components having a planar configuration;
placing the strip components and cover layers around a footwear last;
applying pressure and heat to the strip components and the cover layers to (a) compress the strip components and the cover layers against an exterior surface of the footwear last and (b) mold the strip components and the cover layers to have a non-planar configuration that corresponds with a shape of the exterior surface of the footwear last; and
securing at least one of the strip components and cover layers to a sole structure of the footwear.

29. The method recited in claim 28, wherein the step of locating includes forming a first group of the strip components to have a greater thickness than a second group of the strip components.

30. The method recited in claim 28, wherein the step of locating includes forming the strip components to have edges with an undulating configuration.

31. The method recited in claim 28, wherein the step of locating includes forming (a) a first group of the strip components from a thermoplastic polymer foam material and (b) a second group of the strip components from a polymer material with greater density than the thermoplastic polymer foam material.

32. The method recited in claim 28, wherein the step of locating includes forming at least one of the cover layers from a textile.

33. The method recited in claim 28, wherein the step of securing includes locating one of the cover layers to form at least a portion of an exterior surface of the footwear.
